(19) United States
(12) Patent Application Publication
(10) Pub. No.: US 2013/0174743 A1
(43) Pub. Date: Jul. 11, 2013

(54) AIRCRAFT BREWING APPARATUS

(71) Applicants: Luke E. Kelly, Bonner Springs, KS (US); William D. Aronson, Olathe, KS (US); Sebastien A. Ramus, Olathe, KS (US); Keith R. DeBald, Gardner, KS (US)

(72) Inventors: Luke E. Kelly, Bonner Springs, KS (US); William D. Aronson, Olathe, KS (US); Sebastien A. Ramus, Olathe, KS (US); Keith R. DeBald, Gardner, KS (US)

(73) Assignee: B/E AEROSPACE, INC., Wellington, FL (US)

(21) Appl. No.: 13/733,747

(22) Filed: Jan. 3, 2013

Related U.S. Application Data
(60) Provisional application No. 61/583,801, filed on Jan. 6, 2012.

(51) Int. Cl. A47J 31/00

(52) U.S. Cl. CPC A47J 31/005
USPC 99/291

(57) ABSTRACT

The present invention is a beverage brewing apparatus for an aircraft galley that includes a stow away platen to support a coffee cup or mug during brewing and that can be withdrawn when not in use to eliminate the intrusion of space in the galley if the platen were not stowable. The platen can operate like a pull out drawer, extending from its designated cavity when needed and pushed back into a withdrawn position when finished.

### CROSS-REFERENCES TO RELATED APPLICATIONS

This application claims priority from U.S. Provisional Patent Application No. 61/583,801, filed Jan. 6, 2012, the contents of which are fully incorporated hereby by reference in its entirety.

### BACKGROUND

The present invention relates generally to beverage brewing equipment, and more particularly to a beverage brewing machine particularly suited for a galley of an aircraft.

Commercial aircraft galleys are testaments to efficiency and conservation of weight and space. Every component of the aircraft galley must abide by these principles of conservation and be both compact and efficient, but retain functionality and convenience. One staple, and one of the most relied upon pieces of equipment in the aircraft galley, is the coffee maker. Because it plays such a prominent role, and because it is used so frequently, it is traditionally located in a position of high accessibility and its operation must adhere to the confined space its shares with other surrounding equipment.

A recent trend in coffee brewing apparatus is the use of “pods” or pre-packaged cartridges of coffee that can be single serving or multi-serving. The pod is easily stored and inserted into the coffee brewing apparatus when needed, and the flight attendant does not have to worry about measuring or spilling coffee grounds. The coffee brewing apparatus brings the water to the necessary temperature, punctures, pierces, or otherwise opens the pre-packaged coffee pod to release its contents, and then brews the coffee in single or multiple servings to the preferences of the passengers.

One difficulty with such a brewing apparatus is that it requires a shelf or platen to sit the cup or mug on while the coffee brews. This platen projects from the base of the brewing machine and can protrude into the walkway or tight quarters of the aircraft's galley. Since anything that protrudes into the flight attendant's limited operating space is disfavored, this feature of the brewing apparatus departs from the principles set forth above with respect to compactness and efficiency. Also, the problem of discarded pods creates a storage problem in the galley. That is, once the pods are expended, they must be removed and placed in a storage container to prevent clutter in the galley. As the pods accumulate, they can fall on the floor or behind the brewing apparatus, causing a safety or fire hazard. Moreover, in the case of a coffee brewing apparatus with a single brew head and single brew capability, efficiency and space conservation are not served. It would be beneficial to have a multi-brew configuration so that two different passengers could enjoy different espresso or coffee drinks at the same time without waiting for the first drink to finish brewing.

### SUMMARY OF THE INVENTION

The present invention is a beverage brewing apparatus for an aircraft galley that provides features to improve both efficiency and compactness. In particular, the brewing apparatus of the present invention includes a stow away platen that can be withdrawn when not in use to eliminate the restriction of space in the galley if the platen were not stowable. The platen can operate like a pull out drawer, extending from its designated cavity when needed and pushed back into a withdrawn position when finished. Alternatively, the platen can fold up from a hinged configuration at the bottom like a draw bridge or a “murphy bed.” Other means of stowing the platen inside the brewing apparatus may include sliding the platen in a socket or otherwise removing it from its deployed position when not in use. Another feature of the present invention is a multi-brew head system that can brew multiple beverages with different settings and flavors at the same time. The brewing apparatus of the present invention also has an automatic pod ejection that ejects the spent pod after brewing, and moves the spent pod into a designated internal hopper to capture expended pods. The hopper is concealed from view and can accommodate a large number of pods so that the flight attendants do not need to empty the hopper during the flight.

### BRIEF DESCRIPTION OF THE DRAWINGS

FIG. 1 a perspective front view of the brewing apparatus of the present invention; and

FIG. 2 is a perspective side view of the brewing apparatus of the present invention.

### DETAILED DESCRIPTION OF THE PREFERRED EMBODIMENTS

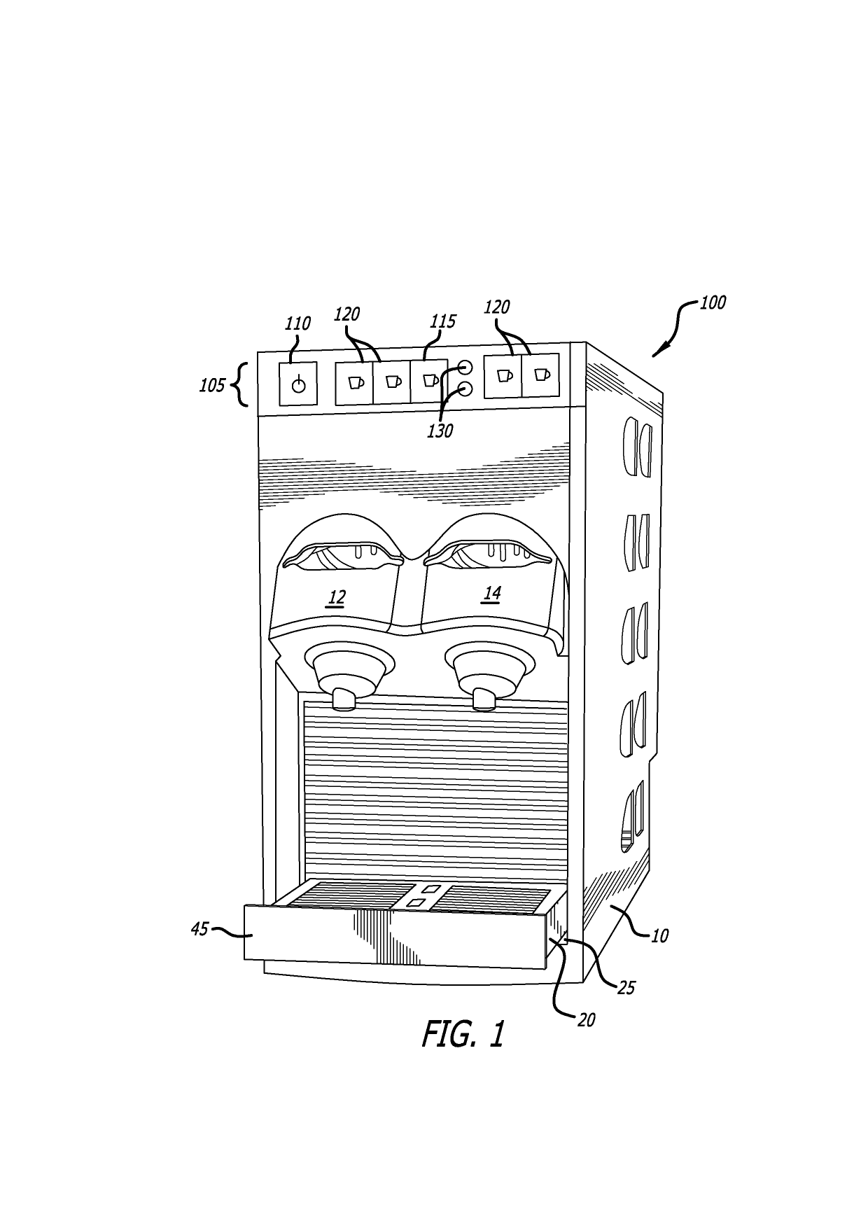

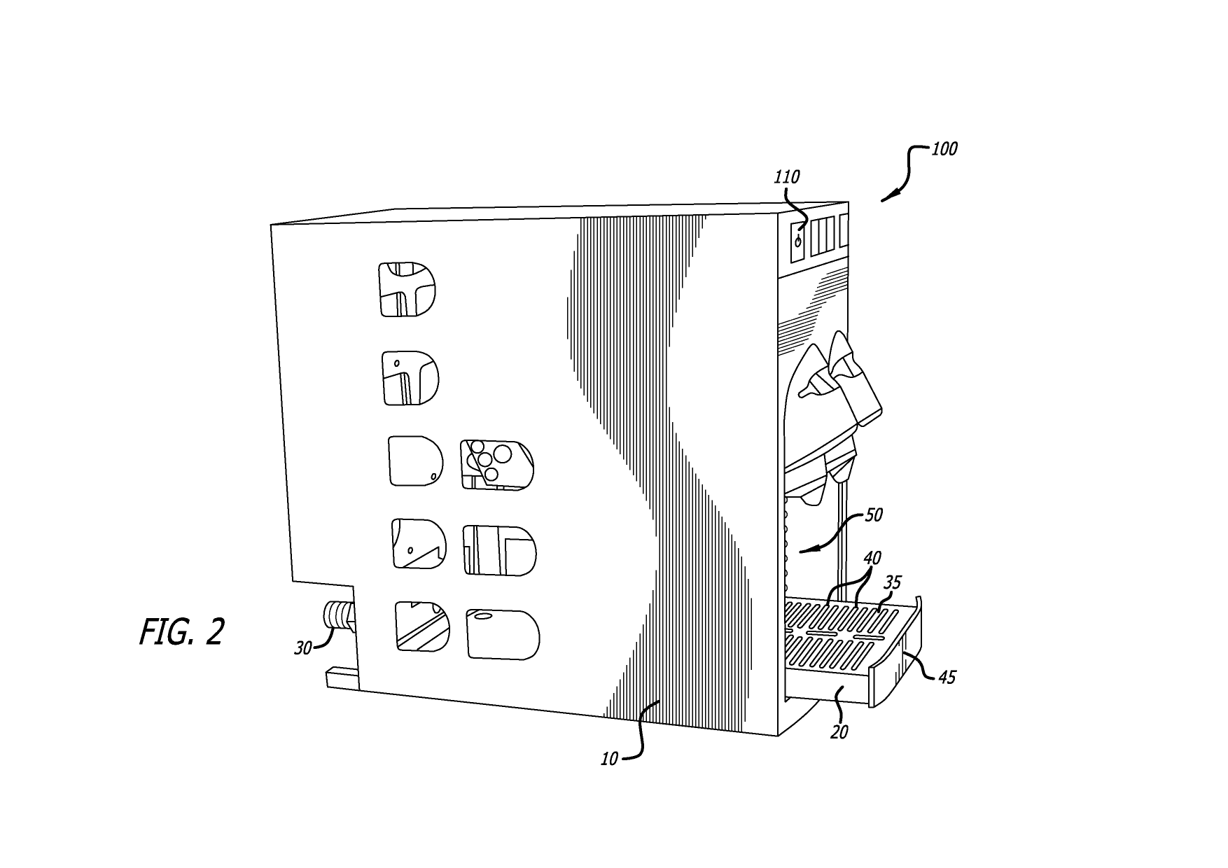

The present invention is an aircraft brewing apparatus and is generally depicted in FIGS. 1 and 2. The brewing apparatus 100 operates in the customary way, and includes a supply of fresh water that is communicated through a fluid line 30 to the brewing station, which is contained in the housing 10. The apparatus 100 has a series of controls 105 that operate the brewing operation, such as a power button 110, a brew button 115, various selection buttons 120 such as espresso or coffee, indicator lights 130, and the like. While the present invention is depicted with two brew heads 12, 14, it is not limited to this number and can include more such brew heads in other embodiments of the invention. Each brew head 12, 14 is independently controlled and can be operated in isolation with the other brew heads. In this manner, multiple passengers can be serviced at the same time without waiting for the machine to cycle, increasing the efficiency of the apparatus.

As can be seen in particular in FIG. 2, the brewing apparatus 100 has a pull-out platen 20 that can be extended when in use from a drawer 25 that it is stowed in. The platen 20 can have a ridged upper surface 35 with grooves 40 that can trapped spilled beverage and prevent the galley floor from becoming wet. Alternatively, there may be frictional tape or other tacky material to prevent a cup from sliding out of the machine when the plane is experiencing turbulence or the like. When in use, the platen 20 extends several inches away from the front surface of the brewing apparatus 100 to accommodate a cup or mug, but when not in use the platen 20 can be stowed in the drawer 25 out of the way. The platen 20 may be formed with a front face 45 that projects upward from the upper surface of the platen 20, which also helps to prevent a cup or mug from sliding out of the brewing apparatus while providing a lip from which the platen 20 can be pulled from the drawer 25. The platen 20 may slide on rails (not shown), or it may just be held by the opening of the drawer 25. To prevent the platen from sliding all of the way out of the apparatus, a stop can be placed on the back side of the platen that is larger than the opening of the drawer 25. In this manner, the platen 20 can be fixed in the drawer 25 so that it will not become dislodged, misplaced, or damaged in some manner.

In addition to sliding in and out of a drawer, the platen 20 can alternatively be hinged at a lower surface so that it can flip up and down in a manner akin to a murphy bed when needed. The platen 20 rotates up against the front surface of the housing 100 in this embodiment, out of the way of the flight attendants and crew members. The platen 20 would be sized to snugly fit within the cavity 50 of the brewing apparatus 100, and hinged at a lower surface by a hinge member (not shown). Other methods of stowing the platen could include a folding operation where the platen folds like an accordion, or otherwise folds upon itself to contract out of the way when not in use.

Another feature of the present invention is the automatic ejection and storage of the spent pods when the brewing operation is complete. The pods, which are typically plastic capsules or miniature disposable cups, can accumulate in the brewing area and clutter the surfaces adjacent the brewing station. To prevent this, the present invention utilizes a pod ejection system that uses a kicker to eject the pods inside the brewing apparatus 100 in a hopper specifically designed to retain the spent pods. The hopper is located within the housing 10 behind the brewing station, and can hold twenty to thirty pods or more. If the pods are first crushed before being ejected, the number of spent pods that can be retained by the hopper approximately doubles. In this manner, there is no need for the flight crew to manually dispose of the spent pods and they cannot find their way to the ground where they can cause a crew member to slip or fall.

The present invention can be used with all kinds of brewing beverages, such as teas, coffees, espressos, and the like. The present invention adds no appreciable weight to the apparatus while conserving space and increasing efficiency. The use of a pull-out or pull-down plate increases the usable space around the brewing apparatus when not in use, and can easily be transferred from one position to the other with minimal effort. Further, the use of two independent brewing heads means that one brewing apparatus can serve twice (or more) as many passengers as a single brew head system. Additionally, the automatic ejection of the spent pods alleviates the crew's need to touch and dispose of the pods and the enclosed hopper provides a convenient location that stores the pods until they can be properly disposed.

We claim:

1. A brewing apparatus for an aircraft comprising:
a housing;
an inlet for receiving a supply of fresh water;
at least two brew heads that can be operated singularly and independently;
a set of user controls for controlling each brew head; and
a pull out platen to support a coffee receptacle, where the pull out platen is adapted to be stowed inside the brewing apparatus when not in use.

2. The brewing apparatus of claim 1 wherein the pull out platen slides out as a drawer from the brewing apparatus.

3. The brewing apparatus of claim 1 wherein the pull out platen comprises a series of grooves on an upper surface to retain a coffee receptacle.

4. The brewing apparatus of claim 1 further comprising a storage area adapted to receive and store used coffee pods spent during a brewing operation.

5. The brewing apparatus of claim 4 further comprising a mechanism for automatically delivering the used coffee pods to the storage area.

6. The brewing apparatus of claim 1 wherein the pull out platen is completely removable from the brewing apparatus.

7. The brewing apparatus of claim 1 wherein the pull out platen has a tacky surface to retain a coffee receptacle thereon.

8. The brewing apparatus of claim 1 wherein the pull out platen is hinged along a first edge to pivot from an extended position to a retracted position.
